(19) United States
(12) Patent Application Publication
(10) Pub. No.: US 2024/0001825 A1
(43) Pub. Date: Jan. 4, 2024

(54) GYROSCOPIC SEAT SYSTEM IN A VEHICLE ENVIRONMENT FOR OCCUPANT SAFETY

(71) Applicant: GM Global Technology Operations LLC, Detroit, MI (US)

(72) Inventors: Tyler P. Morris, Madison Heights, MI (US); Ryan Aaron Gellner, Livonia, MI (US); Nick Colonna, Vaughan (CA)

(21) Appl. No.: 17/856,243

(22) Filed: Jul. 1, 2022

(51) Int. Cl. B60N 2/42

(52) U.S. Cl. CPC B60N 2/42

(57) ABSTRACT

A vehicle includes a restraint system that operates a method of mitigating an effect of an impulse at the vehicle on a passenger of the vehicle. The restrain system includes an inner shell, an outer shell and a slip device between the inner shell and the outer shell. The outer shell is mounted to the vehicle and supports the inner shell. The inner shell supports the passenger. The slip device is configured to allow a relative movement between the inner shell and the outer shell to thereby reduce a transfer of the impulse received at the outer shell to the inner shell.

### INTRODUCTION

The subject disclosure relates to occupant safety in vehicles and, in particular, to a seat assembly for protecting an occupant of a vehicle during a high velocity impact event.

Autonomous vehicles take over the work of operation of the vehicle that would otherwise be performed by a driver. This frees the driver to perform other activities, such as socializing with other passengers of the vehicle. Vehicle seat assemblies are thus able to rotate to facilitate the socializing and to recline at greater angles. In these new orientations, it is becoming more difficult to restrain and protect the occupant in the event of a sudden collision of the vehicle using conventional vehicle safety restraints. Accordingly, it is desirable to provide a seat assembly which is able to absorb impact energy from any angle.

### SUMMARY

In one exemplary embodiment, a method of mitigating an effect of an impulse at a vehicle on a passenger of the vehicle is disclosed. The impulse is received at an outer shell mounted to the vehicle, wherein the outer shell contains an inner shell therein, the passenger being seated at the inner shell. The inner shell moves relative to the outer shell to reduce transfer of the impulse from the outer shell to the inner shell.

In addition to one or more of the features described herein, moving the inner shell relative to the outer shell further includes moving the inner shell within the outer shell. The outer shell and the inner shell are one of an outer seat and an inner seat, respectively, of a seat assembly of the vehicle and a cabin and a chassis, respectively, of the vehicle. A slip device between the outer shell and the inner shell enables motion between the outer shell and the inner shell. The slip device includes at least one of a roller, a ball bearing, a viscous fluid, and a damped spring. The inner shell and the outer shell are connected by a motion restraint, the method further including disconnecting the outer shell from the inner shell when a magnitude of the impulse is greater than an impulse threshold. The method further includes at least one of absorbing the impulse at a damper element between the outer shell and the inner shell and limiting a relative rotation between the outer shell and the inner shell to within selected angular range.

In another exemplary embodiment, a restraint system for a vehicle is disclosed. The restraint system includes an inner shell configured to support a passenger, an outer shell mounted to the vehicle, wherein the outer shell supports the inner shell, and a slip device between the inner shell and the outer shell configured to allow a relative movement between the inner shell and the outer shell to thereby reduce transfer of an impulse received from the outer shell to the inner shell.

In addition to one or more of the features described herein, the slip device allows the relative movement of the inner shell within the outer shell. The outer shell and the inner shell are one of an outer seat and an inner seat, respectively, of a seat assembly of the vehicle and a cabin and a chassis, respectively, of the vehicle. The slip device includes at least one of a roller, a ball bearing, a viscous fluid, and a damped spring. The restraint system further includes a motion restraint connecting the outer shell to the inner shell, wherein the motion restraint prevents relative motion between the outer shell and the inner shell when a magnitude of the impulse is less than an impulse threshold and decouples the outer shell from the inner shell when the magnitude is greater than or equal to the impulse threshold. The impulse threshold corresponds to the magnitude at which other restraint systems are capable of being activated. The restraint system further includes at least one of a damper element between the outer shell and the inner shell for absorbing the impulse and an angular range stop that limits a relative rotation between the outer shell and the inner shell to within selected angular range.

In yet another exemplary embodiment, a vehicle is disclosed. The vehicle includes an inner shell configured to support a passenger, an outer shell mounted to the vehicle, wherein the outer shell supports the inner shell, and a slip device between the inner shell and the outer shell allowing the inner shell to move relative to the outer shell to reduce transfer to the inner shell of an impulse received at the outer shell.

In addition to one or more of the features described herein, the slip device allows a rotation of the inner shell relative to the outer shell. The outer shell and the inner shell are one of an outer seat and an inner seat, respectively, of a seat assembly of the vehicle and a cabin and a chassis, respectively, of the vehicle. The slip device includes at least one of a roller, a ball bearing, a viscous fluid, and a damped spring. The vehicle further includes a motion restraint connecting the outer shell to the inner shell, wherein the motion restraint prevents relative motion between the outer shell and the inner shell when a magnitude of the impulse is less than an impulse threshold and decouples the outer shell from the inner shell when the magnitude is greater than or equal to the impulse threshold. The vehicle further includes at least one of a damper element between the outer shell and the inner shell for absorbing the impulse and an angular range stop that limits a relative rotation between the outer shell and the inner shell to within selected angular range.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in an exemplary embodiment;

FIG. 2 shows a detailed view of a seat assembly of the vehicle in an illustrative embodiment;

FIG. 3 shows a graph illustrating the ability of a seat assembly to absorb impact energy;

FIG. 4 shows an alternate seat assembly in a front view and a side view;

FIG. 5 shows an alternate seat assembly in a front view and a side view; and

FIG. 6 shows an alternate seat assembly in a front view and a side view.

### DETAILED DESCRIPTION

The following description is merely exemplary in nature and is not intended to limit the present disclosure, its application or uses. It should be understood that throughout the drawings, corresponding reference numerals indicate like or corresponding parts and features.

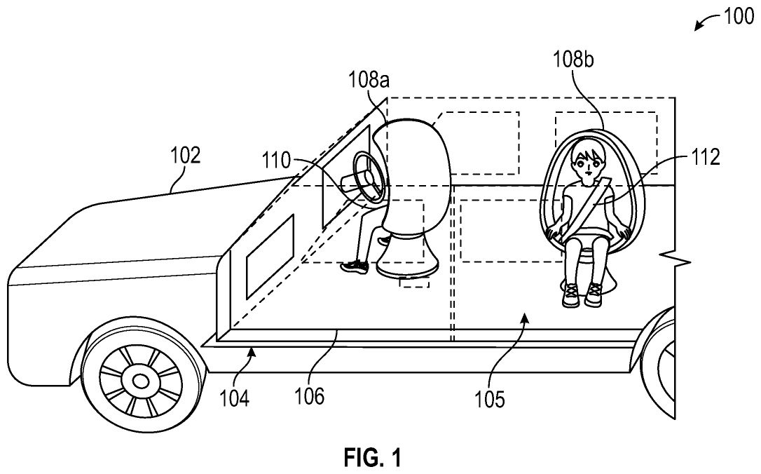

In accordance with an exemplary embodiment, FIG. 1 shows a vehicle 100. The vehicle 100 is shown from a side view with a cabin 105 of the vehicle exposed for illustrative purposes only. The vehicle 100 includes a body 102 having a chassis 104 and a cabin frame 106. The cabin frame 106 supports one or more seat assemblies 108a, 108b. Each seat assembly 108a, 108b seats an occupant, such as driver 110 and passenger 112 and allows the passenger to rotate about a yaw axis. The seat assemblies 108a, 108b also have the ability to recline. When the vehicle 100 is an autonomous vehicle, the driver 110 at some point does not need to be facing forward and can rotate towards another passenger, such as the passenger 112, for social interaction, or to recline in order to relax. The passenger 112 can also have the ability to change the orientation or angle of recline of his seat assembly 108b.

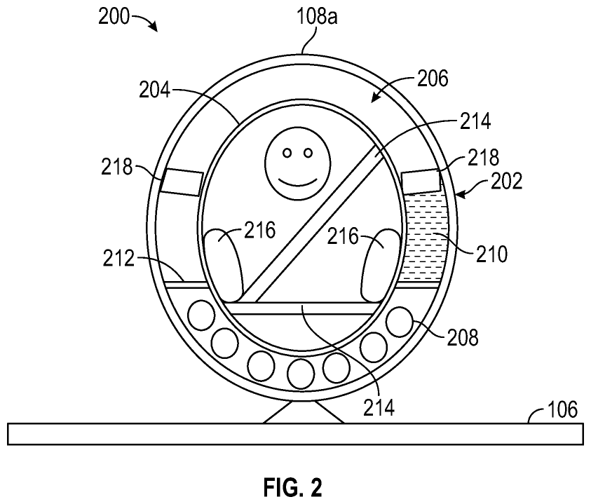

FIG. 2 shows a detailed view 200 of a seat assembly (e.g., seat assembly 108a) in an illustrative embodiment. The seat assembly 108a is an egg-shaped restraint system that includes an outer shell 202 and an inner shell 204 that is supported by, and resides within, the outer shell 202. The seat assembly 108a is shown as an egg shaped assembly but can be any assembly that allows rotational motion, such as circular, etc. The inner shell 204 is an inner seat and the outer shell 202 is an outer seat. The inner shell 204 is separated from the outer shell 202 by a gap 206. The outer shell 202 is mounted to a floor of the cabin frame 106. A slip device 208 resides within the gap 206 and facilitates relative motion between the inner shell 204 and the outer shell 202. The slip device 208 can include a plurality of slip elements. In various embodiments, the slip device 208 allows the inner shell 204 to rotate within the outer shell 202. The slip device 208 can be a roller, a ball bearing, a viscous fluid, etc. A damper element 210 can also reside within the gap to apply a frictional force that reduces the relative motions between the inner shell 204 and the outer shell 202. In various embodiments, the damper element 210 is a viscous fluid.

A motion restraint 212 in the gap connects or engages the inner shell 204 to the outer shell 202. The inner shell 204 is restricted from moving with respect to the outer shell 202 by a motion resistance supplied by the motion restraint 212 but can overcome this motion resistance when a magnitude of a force or impulse on the seat assembly 108a exceeds a selected energy threshold. The motion resistance can be supplied by a shear member, friction, or mechanically. Overcoming of the motion restraint 212 disconnects or disengages the inner shell 204 from the outer shell 202, thereby establishing a relative motion between them. When the force or impulse is less than the selected energy threshold, the motion restraint 212 holds the inner shell 204 and outer shell 202 together, allowing a minimal amount of relative motion between the inner shell and the outer shell. When the force or impulse is greater than the energy threshold, the inner shell 204 decouples from the outer shell 202, thereby allowing a greater degree of relative motion between the inner shell and the outer shell via the slip device 208. The energy threshold of a seat assembly can be tuned to a selected value that corresponds to the weight and size of an occupant in order to minimize a possible injury of the occupant. After the energy has been absorbed, the motion restraint 212 can restore the inner shell 204 to its original pre-impact position within the outer shell 202.

The seat assembly 108a further includes an angular range stop 218 that limits a relative rotation between the outer shell 202 and the inner shell 204 to within a selected angular range. The various embodiments are compatible with existing occupant safety restraint systems, such as the seat belt 214 and airbag 216. In various embodiments, the existing restraint systems can be activated before, after, or simultaneously the resistance of the motion restraint 212 of the seat assembly is overcome.

The slip device 208 and damper element 210 provides relative motion between the inner shell 204 and the outer shell 202. The slip device 208 and damper element 210 are capable of absorbing energy and thus reduce the amount of energy transferred to the inner shell 204 and its occupant. Occupants in seats facing a variety of directions relative to the direction in which the vehicle is travelling are thus able to properly engage with the existing restraint systems (e.g., seat 108, seat belt 214, airbag 216).

In various embodiments, the chassis 104 and the cabin frame 106 can operate using the same mechanism described herein with respect to the outer shell 202 and inner shell 204 of the seat assembly 108a. Thus, a sufficiently large impact on the vehicle 100 can cause the cabin frame 106 to move or rotate with respect to the chassis 104. This restraint system of chassis 104 and cabin frame 106 can be used alternatively or in combination with the seat assembly 108a.

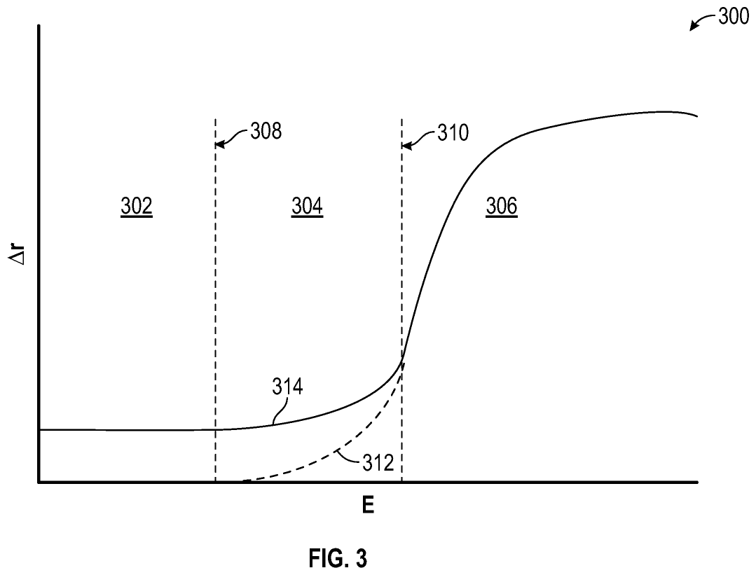

FIG. 3 shows a graph 300 illustrating the ability of a seat assembly 108a to absorb energy. Energy input is shown along the abscissa and relative motion between the inner shell and outer shell is shown along the ordinate axis. The energy input can be in units of energy or, alternatively, in units of Av or of acceleration. The relative motion can be in units of millimeters or radians, in various embodiments. The graph 300 includes exemplary multi-stage regions, such as first region 302, second region 304 and third region 306. The first region 302 defines a region of low energy input that can generally be encountered during normal operation of the vehicle and which can be handled by ordinary operation such as by braking, maneuvering, swerving of the vehicle, etc. In the first region 302, the motion restraint 212 remains intact and allows minimal or no relative motion between the inner shell 204 and the outer shell 202. In the illustrative embodiment depicted by graph 300, the first region 302 has an upper energy input limit at first boundary 308 which can be designed at or adjusted to an energy input value that minimizes the injury to an occupant.

The second region 304 defines a region of intermediate energy input that can coincide with other restraint systems. The second region 304 is limited at a lower energy input limit at first boundary 308 and an upper energy input limit at second boundary 310. In the second region 304, relative motion occurs between the inner shell 204 and outer shell 202 within the elastic deformation range of the motion restraint 212.

The third region 306 defines a high energy input zone that coincides with other restraint systems. Such energy inputs can be due to the impact of the vehicle. The third region 306 is limited at a lower energy input limit (i.e., second boundary 310). In the third region 306, the inner shell 204 can move relative to, or rotate within, the outer shell 202 with little or no resistance.

Curve 312 shows a first movement profile. A seat assembly having the first movement profile of curve 312 allows no movement during normal use in first region 302 and absorbs impact energy in the second region 304 and the third region 306. Curve 314 shows a second movement profile. A seat assembly having the second movement profile of curve 314 allows some or minimal movement during normal use in first region 302 and absorbs impact energy in the second region 304 and the third region 306.

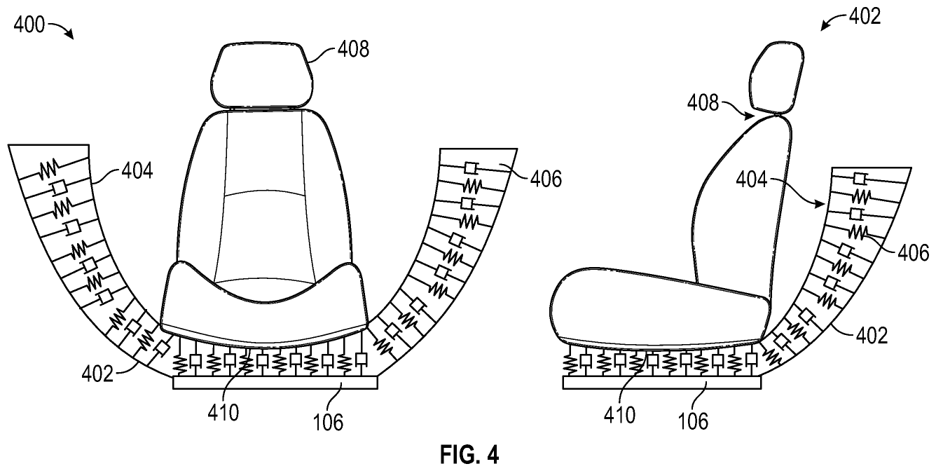

FIG. 4 shows an alternate seat assembly 400 in a front view and a side view. The alternate seat assembly 400 includes an outer shell 402 connected to an inner shell 404 via a damped spring system 406. The outer shell 402 and inner shell 404 can be half shells or partial shells. The outer shell 402 is coupled to the cabin frame 106 of the vehicle and a seat 408 is coupled to the inner shell 404 via a seat bottom or seat track 410 which allows the seat 408 rotational and reclining flexibility within the inner shell.

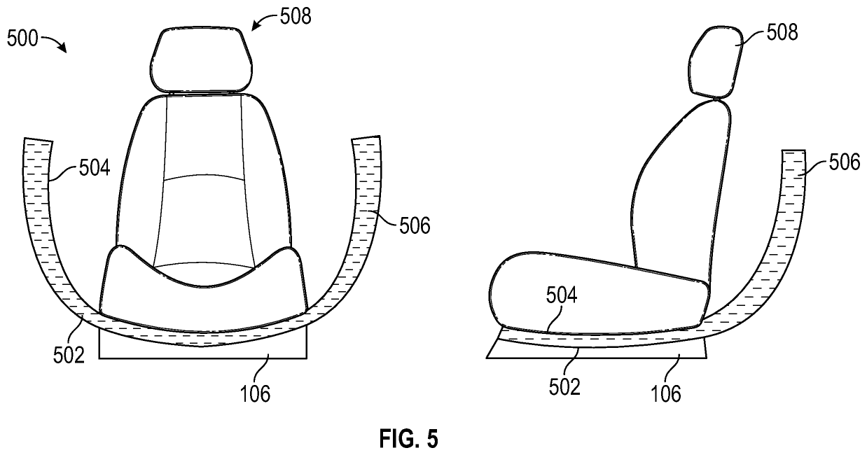

FIG. 5 shows an alternate seat assembly 500 in a front view and a side view. The alternate seat assembly 500 includes an outer shell 502, an inner shell 504, and a viscous fluid 506 in a cavity between the outer shell 502 and the inner shell 504. The outer shell 502 and inner shell 504 can be half shells or partial shells. The outer shell 502 is coupled to the cabin frame 106 of the vehicle and a seat 508 is coupled to the inner shell 504 and can rotate and recline within the inner shell.

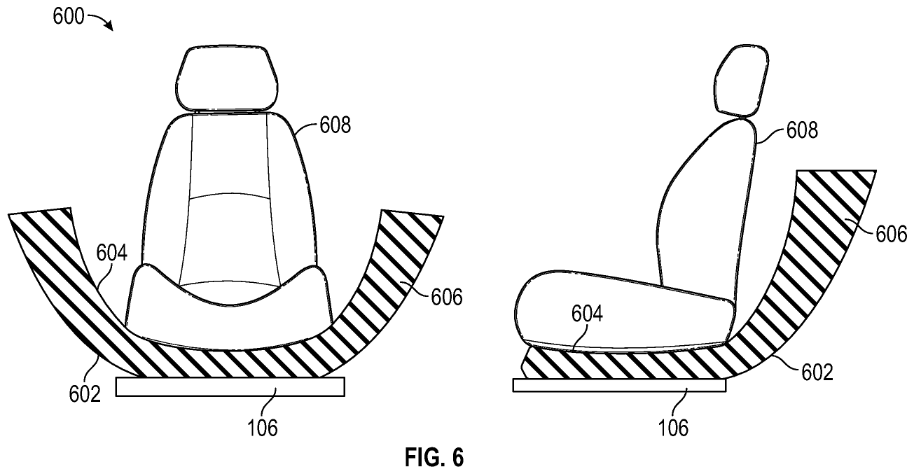

FIG. 6 shows an alternate seat assembly 600 in a front view and a side view. The alternate seat assembly 600 includes an outer shell 602 connected to an inner shell 604 via a viscoelastic/shear material 606. The outer shell 602 and inner shell 604 are half-shells or partial shells. The outer shell 602 is coupled to the cabin frame 106 of the vehicle and a seat 608 is coupled to the inner shell 604 and can rotate and recline within the inner shell.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of mitigating an effect of an impulse at a vehicle on a passenger of the vehicle, comprising:
receiving the impulse at an outer shell mounted to the vehicle, wherein the outer shell contains an inner shell therein, the passenger being seated at the inner shell; and
moving the inner shell relative to the outer shell to reduce transfer of the impulse from the outer shell to the inner shell.

2. The method of claim 1, wherein the moving the inner shell relative to the outer shell further comprises moving the inner shell within the outer shell.

3. The method of claim 1, wherein the outer shell and the inner shell are one of: (i) an outer seat and an inner seat, respectively, of a seat assembly of the vehicle; and (ii) a cabin and a chassis, respectively, of the vehicle.

4. The method of claim 1, wherein a slip device between the outer shell and the inner shell enables motion between the outer shell and the inner shell.

5. The method of claim 4, wherein the slip device includes at least one of: (i) a roller; (ii) a ball bearing; (iii) a viscous fluid; and (iv) a damped spring.

6. The method of claim 1, wherein the inner shell and the outer shell are connected by a motion restraint, further comprising disconnecting the outer shell from the inner shell when a magnitude of the impulse is greater than an impulse threshold.

7. The method of claim 1, further comprising at least one of: (i) absorbing the impulse at a damper element between the outer shell and the inner shell; and (ii) limiting a relative rotation between the outer shell and the inner shell to within selected angular range.

8. A restraint system for a vehicle, comprising:
an inner shell configured to support a passenger;
an outer shell mounted to the vehicle, wherein the outer shell supports the inner shell; and
a slip device between the inner shell and the outer shell configured to allow a relative movement between the inner shell and the outer shell to thereby reduce transfer of an impulse received from the outer shell to the inner shell.

9. The restraint system of claim 8, wherein the slip device allows the relative movement of the inner shell within the outer shell.

10. The restraint system of claim 8, wherein the outer shell and the inner shell are one of: (i) an outer seat and an inner seat, respectively, of a seat assembly of the vehicle; and (ii) a cabin and a chassis, respectively, of the vehicle.

11. The restraint system of claim 8, wherein the slip device includes at least one of: (i) a roller; (ii) a ball bearing; and (iii) a viscous fluid.

12. The restraint system of claim 8, further comprising a motion restraint connecting the outer shell to the inner shell, wherein the motion restraint prevents relative motion between the outer shell and the inner shell when a magnitude of the impulse is less than an impulse threshold and decouples the outer shell from the inner shell when the magnitude is greater than or equal to the impulse threshold.

13. The restraint system of claim 12, wherein the impulse threshold corresponds to the magnitude at which other restraint systems are capable of being activated.

14. The restraint system of claim 8, further comprising at least one of: (i) a damper element between the outer shell and the inner shell for absorbing the impulse; and (ii) an angular range stop that limits a relative rotation between the outer shell and the inner shell to within selected angular range.

15. A vehicle, comprising:
an inner shell configured to support a passenger;
an outer shell mounted to the vehicle, wherein the outer shell supports the inner shell; and
a slip device between the inner shell and the outer shell allowing the inner shell to move relative to the outer shell to reduce transfer to the inner shell of an impulse received at the outer shell.

16. The vehicle of claim 15, wherein the slip device allows a rotation of the inner shell relative to the outer shell.

17. The vehicle of claim 15, wherein the outer shell and the inner shell are one of: (i) an outer seat and an inner seat, respectively, of a seat assembly of the vehicle; and (ii) a cabin and a chassis, respectively, of the vehicle.

18. The vehicle of claim 15, wherein the slip device includes at least one of: (i) a roller; (ii) a ball bearing; and (iii) a viscous fluid.

19. The vehicle of claim 15, further comprising a motion restraint connecting the outer shell to the inner shell, wherein the motion restraint prevents relative motion between the outer shell and the inner shell when a magnitude of the impulse is less than an impulse threshold and decouples the outer shell from the inner shell when the magnitude is greater than or equal to the impulse threshold.

20. The vehicle of claim 15, further comprising at least one of: (i) a damper element between the outer shell and the inner shell for absorbing the impulse; and (ii) an angular range stop that limits a relative rotation between the outer shell and the inner shell to within selected angular range.
